(19) United States
(12) Patent Application Publication
(10) Pub. No.: US 2022/0184460 A1
(43) Pub. Date: Jun. 16, 2022

(54) GOLF BALLS HAVING COVERS WITH DECORATIVE EFFECT COATINGS

(71) Applicant: Acushnet Company, Fairhaven, MA (US)

(72) Inventors: Michael J. Sullivan, Old Lyme, CT (US); Mark L. Binette, Mattapoisett, MA (US)

(73) Assignee: Acushnet Company, Fairhaven, MA (US)

(21) Appl. No.: 17/539,853

(22) Filed: Dec. 1, 2021

Related U.S. Application Data
(60) Provisional application No. 63/125,080, filed on Dec. 14, 2020.

(51) Int. Cl. A63B 37/00; C09D 1/00

(52) U.S. Cl. CPC A63B 37/00223; A63B 37/0015; C09D 1/00; A63B 37/0074; A63B 37/00222

(57) ABSTRACT

Golf balls having covers with decorative-effect coatings are provided. The golf balls are fashionable and decorative with unique appearances. In one embodiment, a golf ball comprising a core having at least one layer and cover having at least one layer is provided. The outer cover surface can have surface textured dimples and a decorative-effect first coating can be applied to this outer surface. A transparent second coating can be applied over the decorative-effect coating. In another embodiment, a semi-transparent metallic first coating overlies the outer cover surface and a decorative-effect second coating overlies the metallic coating.

### CROSS-REFERENCE TO RELATED APPLICATIONS

This application claims the benefit of U.S. Provisional Application No. 63/125,080, filed Dec. 14, 2020, the entire disclosure of which is incorporated by reference.

### BACKGROUND OF THE INVENTION

### Field of the Invention

The present invention generally relates to golf balls having covers with decorative-effect coatings. The outer cover surface can have surface textured dimples and a decorative-effect first coating can be applied to this outer surface. A transparent second coating can be applied over the decorative-effect coating. In another embodiment, a semi-transparent metallic first coating overlies the outer cover surface and a decorative-effect second coating overlies the metallic coating. The resulting golf balls have unique and appealing appearances.

### Brief Review of the Related Art

Both professional and amateur golfer use multi-piece, solid golf balls today. Basically, a two-piece solid golf ball includes a solid inner core protected by an outer cover. The inner core is normally made of a natural or synthetic rubber such as polybutadiene, styrene butadiene, or polyisoprene. The cover surrounds the inner core and can be made of a variety of materials including ethylene acid copolymer ionomers, polyamides, polyesters, polyurethanes, and polyureas.

Three-piece, four-piece, and even five-piece balls have become more popular over the years. More golfers are playing with these multi-piece balls for several reasons including new manufacturing technologies, lower material costs, and desirable ball playing performance properties. Many golf balls used today have multi-layered cores comprising an inner core and at least one surrounding outer core layer. For example, the inner core may be made of a relatively soft and resilient material, while the outer core may be made of a harder and more rigid material. The “dual-core” sub-assembly is encapsulated by a single or multi-layered cover to provide a final ball assembly. Different materials are used in these golf ball constructions to impart specific properties and playing features to the ball.

For instance, ionomer compositions comprising an ethylene acid copolymer containing acid groups that are at least partially neutralized can be used to make golf ball covers. Suitable ethylene acid copolymers that may be used to form the cover layers are generally referred to as copolymers of ethylene; C₃ to C₈ α, β-ethylenically unsaturated mono-or dicarboxylic acid; and optional softening monomer. Commercially available ionomer compositions that can be used to make such covers include Surlyn® (DuPont) and Escor® and Iotek® (Exxon) ionomers. In recent years, there has been high interest in using thermoset and thermoplastic polyurethane compositions to make golf ball covers. Different molding operations can be used to form the cover over the core or sub-assembly of the ball. For example, compression-molding, casting, and injection-molding processes can be use.

After the golf balls have been removed from the mold, they are normally subjected to finishing steps including flash-trimming, surface-treatment, marking, and application of coatings. Optical brighteners can be included in the cover stock material used to make the cover layer, in primer coatings, in paints, and in topcoat compositions. When applied to the exterior of a golf ball, optical brighteners enhance the whiteness and/or brightness of such balls. Clear topcoats are often applied to the cover of the golf ball. The topcoats protect the ball and any underlying clear or pigmented layers. The topcoats also protect any trademarks, tradenames logos, and other indicia printed on the ball. The topcoats normally have a high gloss finish.

Golf balls are available today in a wide variety of colors such as, for example, white, yellow, orange, green, red, and pink. In recent years, manufacturers have looked at developing golf balls having special decorative effects. For example, Morgan et al., U.S. Patent Application Publication 2004/0176188 discloses golf ball comprising a core, a cover, and at least one intermediate layer therebetween. The intermediate layer includes pigment which contributes to the color of the ball and the cover is at least partially transparent such that the intermediate layer is at least partially visible. The cover also comprises an optical enhancer such as a florescent dye, optical brightener or an optical active chemical additive.

Sullivan et al., U.S. Pat. No. 9,295,882 discloses a golf ball comprising a core and composite layer, wherein the composite layer comprises a fibrous material dispersed in a translucent polymer matrix. An outer translucent cover layer is preferably disposed about the composite layer.

Comeau et al., U.S. Pat. No. 9,433,826 discloses a golf ball comprising a substrate layer that is formed from a thermoset or thermoplastic composition and having an outer surface that is pre-modified with a catalytic coating; a metallic film that is formed about the outer surface by contacting the catalytic coating with a mixture comprising: (i) at least one aqueous and/or organic aerosol comprising at least one metal in cationic/oxidizing form; and (ii) at least one reducing agent; and a layer surrounding the metallic film that is formed from a thermoset or thermoplastic composition.

Although some special decorative-effect golf balls have been developed, there is still a need for new, aesthetically-pleasing golf balls. The golf balls should be cost-effective and be capable of being produced in a wide variety of colors. The golf balls should have a distinctive look when viewed at different viewing angles. The present invention provides such golf balls. The finished golf balls have a unique and appealing look along with other advantageous features and benefits.

### SUMMARY OF THE INVENTION

The present invention generally relates to golf balls having unique and appealing appearances. The golf balls are fashionable and decorative and available in a wide variety of colors. In one embodiment, a golf ball comprising a core having at least one layer and a cover having at least one layer is provided, wherein the cover comprises: i) an outer surface having dimples disposed thereon, at least a portion of the dimples comprising a perimeter and an inner surface, wherein the inner surfaces comprise at least one indented or protruding member, ii) a semi-transparent decorative-effect first coating overlying the outer surface of the cover, the decorative-effect coating comprising a color-shifting pigment such that the pigment has a first color at a first viewing angle and a second color different from the first color at a second viewing angle; and iii) a transparent second coating overlying the decorative-effect first coating.

The golf ball dimples can have different surface texturing and patterns. For example, the inner surfaces of the dimples may comprise at least one indented channel, particularly at least two indented channels, wherein the channels are linear and at least two of the channels have the same channel length and channel width. In another example, the dimple inner surfaces comprise at least one indented sub-dimple. In yet another example, the dimple inner surfaces comprise at least one protruding ridge. The decorative-effect coating may comprise a decorative material selected from the group consisting of phosphorescent pigments, luminescent pigments, light-reflective pigments, metallic pigments, pearlescent pigments, edge-effect pigments, color pigments and dyes, and mixtures thereof. In one example, the decorative-effect coating has a thickness in the range of about 0.1 μm to about 50 μm.

In another embodiment, the golf ball comprises a core having at least one layer and a cover having at least one layer, wherein the cover comprises: i) an outer surface having dimples disposed thereon, the dimples overlying a layer comprising a series of protruding members that provide a concavo-convex pattern; ii) a semi-transparent metallic first coating overlying the outer surface of the cover, the metallic coating comprising a metallic pigment; and iii) a transparent second coating overlying the metallic first coating. In one particular example, the semi-transparent metallic coating provides a decorative design on the outer surface of the cover, wherein the decorative design appears and disappears depending upon the viewing angle. The semi-transparent metallic coating may comprise a metallic pigment selected from the group consisting of aluminum, titanium dioxide, iron oxide, and zinc pigments, metal-oxide coated mica pigments, and mixtures thereof. In one example, the mica pigments are coated with titanium oxide or iron oxide. In another example, the metallic coating comprises a pigment mixture composition of: (a) a metal-oxide coated mica pigment in an amount of about 5 wt. % to about 50 wt. %; and (b) titanium dioxide-coated aluminum pigment in an amount of about 50 wt. % to about 95 wt. %. The metallic coating may comprise the pigment mixture composition in an amount of about 1% to about 30 wt. % based on total solids in the semi-transparent metallic coating. In yet another example, the metallic coating further comprises a metal film. The metallic coating may comprise a decorative material selected from the group consisting of phosphorescent pigments, luminescent pigments, edge-effect pigments, color pigments and dyes and mixtures thereof. In one example, the metallic coating has a thickness in the range of about 0.1 μm to about 50 μm.

In yet another embodiment, the golf ball comprises a core having at least one layer and a cover having at least one layer, wherein the cover comprises: i) an outer surface having dimples disposed thereon, the dimples overlying a layer comprising a series of protruding members that provide a concavo-convex pattern; ii) a semi-transparent metallic first coating overlying the outer surface of the cover; iii) a semi-transparent decorative-effect second coating overlying the metallic first coating, wherein the decorative-effect coating comprises a decorative material selected from the group consisting of color-shifting pigments, phosphorescent pigments, luminescent pigments, light-reflective pigments, metallic pigments, pearlescent pigments, edge-effect pigments, color pigments and dyes, and mixtures thereof; and iv) a transparent third coating overlying the decorative-effect second coating. In one example, the decorative material is a color-shifting pigment such that the pigment has a first color at a first viewing angle and a second color different from the first color at a second viewing angle. In another example, the decorative material is a light-reflective white pigment or a pearlescent pigment.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is an enlarged cross-sectional view of a dimple having surface texturing in accordance with the present invention;

FIG. 2 is a front view of a golf ball having dimples with surface texturing in accordance with the present invention;

FIG. 3 is a perspective view of a golf ball having surface channel patterns in accordance with the present invention;

FIG. 4A is a half-profile view of a golf ball having a having a surface channel pattern in accordance with the present invention;

FIG. 4B is a half-profile view of a golf ball having a having a raised bead pattern in accordance with the present invention;

FIG. 5 is a top view of a portion of a golf ball having dimples with surface texturing in accordance with the present invention;

FIG. 6 is a front view of a golf ball having dimples with surface texturing in accordance with the present invention; and

FIG. 7 is a cross-sectional view of a golf ball having a base sub-coating layer with a concavo-convex pattern in accordance with this invention.

### DETAILED DESCRIPTION OF THE INVENTION

Golf balls having various constructions may be made in accordance with this invention. For example, golf balls having two-piece, three-piece, and four-piece constructions with single or multi-layered cover materials may be made. Representative illustrations of such golf ball constructions are provided and discussed further below. The term, “layer” as used herein means generally any spherical portion of the golf ball. More particularly, in one version, a two-piece golf ball containing a core with a surrounding cover is made. Three-piece golf balls containing a dual-layered core and single-layered cover also can be made. The dual-core includes an inner core (center) and surrounding outer core layer. In another version, a four-piece golf ball containing a dual-core and dual-cover (inner cover and outer cover layers) is made. In yet another construction, a four-piece or five-piece golf ball containing a dual-core; casing layer(s); and cover layer(s) may be made. As used herein, the term, “casing layer” means a layer of the ball disposed between the multi-layered core assembly and cover. The casing layer also may be referred to as a mantle or intermediate layer. The diameter and thickness of the different layers along with properties such as hardness and compression may vary depending upon the construction and desired playing performance properties of the golf ball.

Golf balls generally include a spherical outer surface with a plurality of dimples formed thereon. In conventional golf balls, the dimples are normally spherical dimples with circular plan shapes that help reduce drag and increase lift of the golf ball. In general, dimples are formed in the golf ball surface as recesses or indentations. These dimples are formed where a dimple wall slopes away from the outer surface of the ball, thus forming the depression. Multiple dimples are distributed at close spacing over the outer surface of the golf ball. The cross-sectional shape of dimples is defined by a portion of a curved surface such as a circle, ellipse or hyper-ellipse. Dimple cross-sectional shapes also include straight surfaces such as, for example, conical, conical frustum, spherical-polygonal dimples, and the like. Referring to FIG. 1, the cross-sectional shape of the curved surface of the dimple (10) is a portion of a circle as described in further detail below. Normally, the dimple is circular and has a diameter in the range of about 0.050 to about 0.250 inches and a dimple depth in the range of about 0.002 to about 0.020 inches. The surface of the golf ball may contain dimples having non-circular plan shapes rather than circular plan shapes. For example, the dimple plan shape may be triangular, rectangular, pentagonal, hexagonal, or any other suitable regular or irregular polygonal shape. In other embodiments, the golf ball surface may contain both dimples having circular and non-circular plan shapes. The total number of dimples can vary as is known in the art and is generally in the range of about 200 to 600.

In FIG. 1, the dimple (10) is circumscribed by an upper perimeter edge (12) which is continuously connected to a land (15) of the golf ball surface where no dimples are formed. The edge (12) is generally beveled from the land (15) as a steep slope to form the dimple. The edge (12) is formed angular prior to paint coating and somewhat rounded after paint coating. In general, the diameter of the dimple (10) is determined on the basis of the geometry (normally circular) circumscribed by the dimple edge (12). The dimple has an inner curved surface (18). The depth of the dimple (10) is given by the distance between the bottom (21) of the inner surface (18) and the original ball surface depicted by an imaginary extension line (24) drawn on the assumption that the ball has no dimples. The diameter of the dimple (10) is the distance between a dimple edge and its equivalent point diametrically opposite along the dimple perimeter. In FIG. 1, the inner surface (18) of the dimple (10) has secondary surface texturing as generally indicated at (23) and described in further detail below.

Historically, dimple patterns for golf balls have had a variety of geometric shapes, patterns, and configurations. Primarily, patterns are laid out in order to provide desired performance characteristics based on the particular ball construction, material attributes, and player characteristics influencing the ball's initial launch angle and spin conditions. Therefore, dimple pattern development is a secondary design step that is used to achieve the appropriate aerodynamic behavior, thereby tailoring ball flight characteristics and performance attributes.

In attempts to improve aerodynamic symmetry, many dimple patterns have been developed based on geometric shapes. These may include circles, hexagons, triangles, and the like. Other dimple patterns are based in general on the five Platonic Solids including icosahedron, dodecahedron, octahedron, cube, or tetrahedron. Yet other dimple patterns are based on the thirteen Archimedian Solids, such as the small icosidodecahedron, rhomicosidodecahedron, small rhombicuboctahedron, snub cube, snub dodecahedron, or truncated icosahedron. Furthermore, other dimple patterns are based on hexagonal dipyramids. Dimple properties such as number, shape, size, volume, edge angles and arrangement are often manipulated in an attempt to generate a golf ball that has improved aerodynamic properties.

### Base (Sub-Coating) Layer

The outer surface of the golf balls of this invention can have various surface texturing. This surface textured outer surface of the golf ball can have various surface patterns and be referred to as the base or sub-coating layer. The base layer is coated with a semi-transparent metallic coating, and/or a decorative effect coating, and/or a transparent topcoat as described further below. The combination of the base layer and coating layers provides a special aesthetic effect to the golf ball also as described further below. By “surface texturing” as used herein, it is meant forming indentations or protrusions within the dimple, or on the non-dimpled (land) surface of the outer surface of the golf ball, or both within the dimple and the non-dimpled land surface. For example, as described above and shown in FIG. 1, the dimples (10) may comprise a perimeter with edge (12) and an inner surface (18). The inner surface (18) may be surface textured (23) in accordance with this invention such that the inner surface comprises at least one protrusion or indentation. Preferably, a plurality of protrusions and/or indentations are formed. The plurality of indentations or protrusions can form aligned arrangements within the dimple.

These indentations or protrusions can be arranged randomly or in geometric order. For example, the indented or protruding members can be arranged in a grid or lattice. These indented members may be in any suitable form such as, for example, indentations, groves, channels, tunnels, cavities, recessed portions, depressions, and the like. The protruding members also may be in any suitable form such as, for example, ridges, bumps, nubs, hooks, juts, ribs, segments, brambles, ribs, spines, points, projections, extensions, raised members, and the like. The indentations and protrusions may have any suitable shape and dimensions. For example, the protrusions may have a circular, oval, triangular, square, rectangular, pentagonal, hexagonal, heptagonal, or octagonal shape. Conical-shaped protrusions also may be used. The indentations and protrusions may be arranged in linear or non-linear patterns such as arcs and curves. The indentations and protrusions may be configured so there are gaps or channels located between them. These indentations and protrusions can be arranged so the inner surface of the dimple has a series of peaks and valleys.

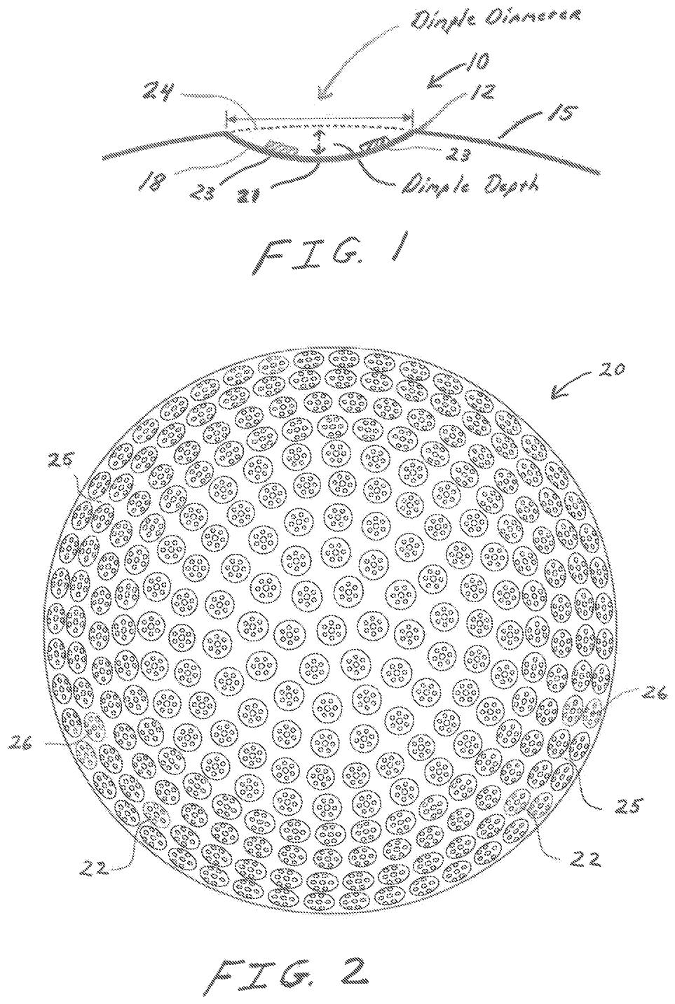

Different surface texturing of the dimples may be used in accordance with the present invention. For example, Sullivan, U.S. Pat. No. 6,569,038, the disclosure of which is hereby incorporated by reference, discloses a golf ball having dimples with structures therein to energize or agitate the airflow over the dimpled surface to increase the aerodynamic performance of the ball. These structures include sub-dimples and radiating convex or concave arms emanating from the center of the dimple. As shown generally in FIG. 2, the golf ball (20) has a plurality of dimples (22) separated by outer undimpled or land surface (25). The dimples (22) may have sub-dimples (26) defined on thereon to further agitate or energize the turbulent flow over the dimples and to reduce the tendency for separation of the turbulent boundary layer around the golf ball in flight. The sub-dimples (26) may have various shapes and sizes, as long as they contribute to the agitation of the air flowing over the dimples.

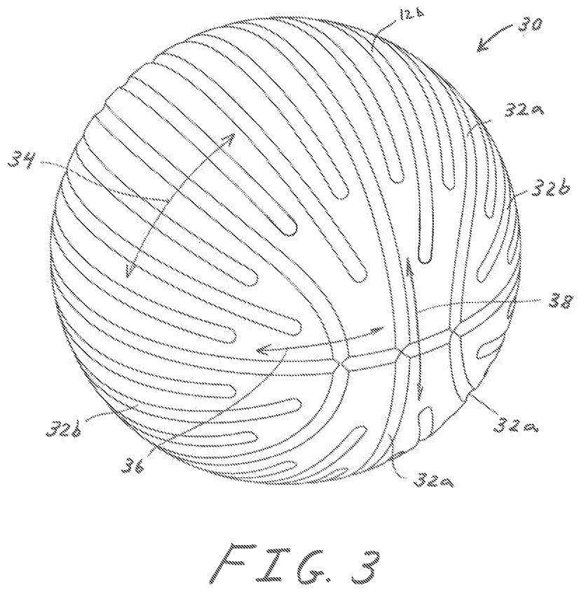

In another embodiment, the golf ball can have one or more channels or ridges on its surface as described in Sullivan et al., U.S. Pat. No. 8,137,216, the disclosure of which is hereby incorporated by reference. These channels or ridges may be linear, or may be curved, and may or may not fully circumscribe the golf ball. The channels may or may not intersect other channels. These channels or ridges may also be combined with traditional or non-traditional dimples. In one example, referring to FIG. 3, the ball (30) has a channel system comprising interconnecting channels (32a) and non-connecting channels (32b), collectively referred to as channels (32). In this embodiment, channels (32) comprise about 37% of the land surface. The channels (32) provide the ball (30) with unique orientation-specific aerodynamic properties. The ball (30) can be orientated at tee-off with arrow (34), (36), or (38) at the top of the ball and pointed along the target line. When the ball (30) is struck along arrow (14), it will have back spin in the direction of arrow (14). The airflow over the ball (30) would flow across the most channels (32) in this embodiment resulting in the most lift and causing the ball to have a relatively high trajectory and greater carry distance. When the ball (30) is struck along arrows (16) or (18), the airflow over the ball would flow along a plurality of channels (32) and across a smaller number of channels, resulting in less lift and causing the ball to have a shallower trajectory and less carry distance. Preferably, the surface coverage of channels (32) is in the range of about 5% to about 40% and the dimple coverage can be from about 40% to about 90%, with a total dimple/channel coverage ranging from about 60% to 95%.

In another example, the non-dimpled, land area is surface-textured. Morgan et al., U.S. Pat. No. 8,329,081, the disclosure of which is hereby incorporated by reference, discloses a method of forming a golf ball with secondary surface texture created on the fret (land) areas of a ball. The secondary surface texture is created on the golf ball hob prior to the primary dimples being formed into the hob. When the dimples are formed, they largely obliterate the secondary surface texture except for the fret area and the perimeter of the dimples.

In Aoyama et al., U.S. Pat. No. 8,808,113, the disclosure of which is hereby incorporated by reference, the golf ball has one or more bands or channels on its surface. The bands form spherical polygonal tiles having a system of variable width and/or height/depth ridges or channels on the golf ball surface. The channels may be straight or curved, may or may not circumscribe the golf ball. The channels may also be discontinuous. The channels may or may not intersect other channels. The channels may cover as much of the ball surface as desired, up to virtually 100%, but preferably the surface coverage of the channels is less than about 40%. The outer surface of the golf ball may include other surface patterns such as, for example, dimples with different surface texturing and conventional dimples as described above.

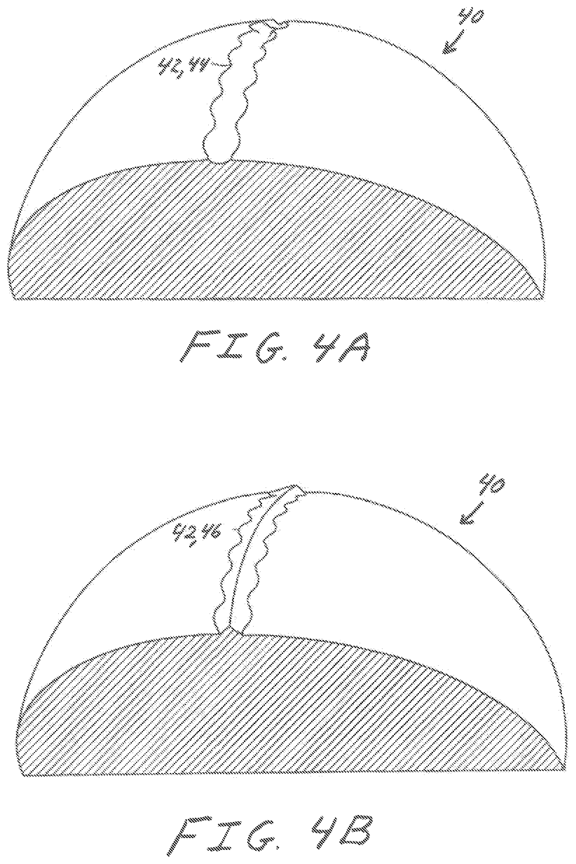

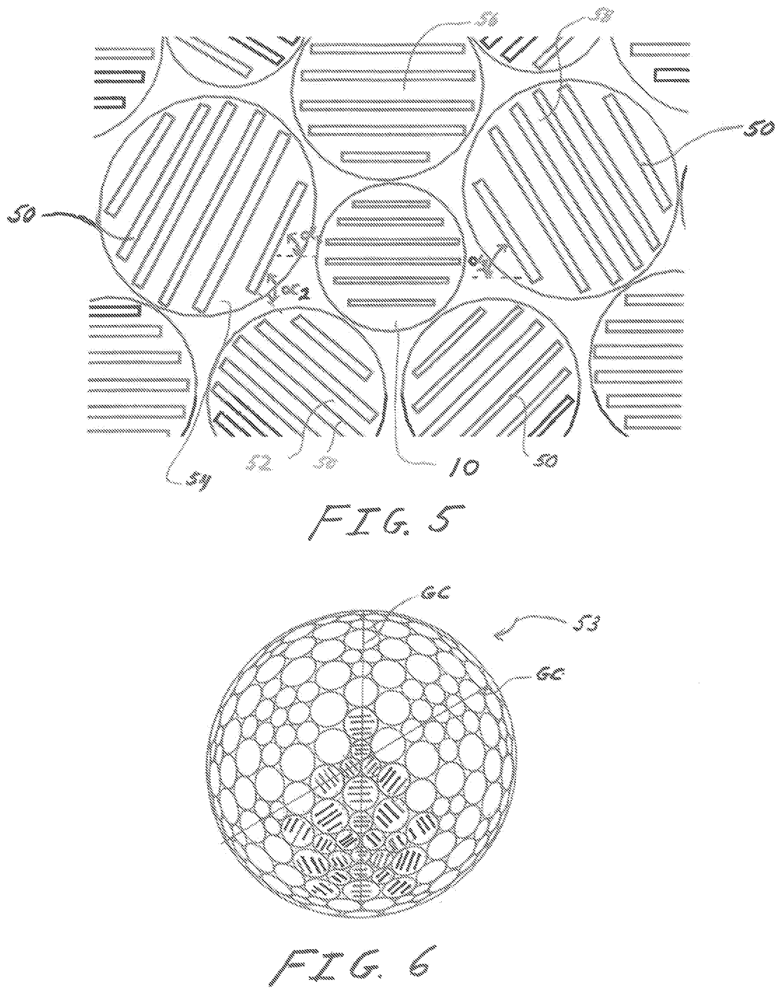

In one embodiment, as illustrated in FIGS. 4A and 4B, the golf ball (40) comprises one or more bands (42) to improve the ball's aerodynamics. A band (42) may be a surface channel (44), or a raised bead (46). The channels (44) have an elevation lower than the outer surface of ball (40), and the beads (46) have an elevation higher than the outer surface of the ball. The bands (42) have a variable width and/or depth/height, either within the same band (intra-band) or between bands (inter-band), and may be continuous or discontinuous. The bands (42) may have any desired shape or pattern. This may include, but is not limited to, geometric patterns, fractal patterns, irregular patterns, linear and non-linear lines, and the like.

In Madson et al., U.S. Pat. No. 10,758,784, the disclosure of which is hereby incorporated by reference, dimples incorporating linear channels having a channel length (L) and a channel width (CW) are disclosed. In a preferred embodiment of the invention, the outer surface of the golf ball comprises less than 360 dimples and all of the dimples incorporate directional surface texturing made up of substantially linear arrangements that are aligned. The linear arrangements, like the linear channels (50) disclosed in FIG. 5, are preferably substantially parallel to each other and extend across a substantial portion of the dimple. While the linear channels shown in FIG. 5 are parallel within each dimple, they are at offset angles a with respect to adjacent dimples. The linear channels (50) within a dimple are disposed at angles of between about 10 and 90 degrees with respect to the linear channels (50) of an adjacent dimple. For example, dimple (10) includes linear channels (50) that are disposed at an angle α of between 10 and 90 degrees with respect to each of the adjacent dimples (52), (54), (56), and (58). As shown, the linear channel (50), angles α₁ and α₂ are about 60 degrees and α₃ is about 90 degrees. Preferably, the linear channels (50) are arranged at an angle α of between about 30 and 90 degrees with respect to most of the adjacent dimples. In some arrangements, the golf ball can be designed such that no dimple on the ball has an adjacent dimple with parallel linear arrangements. As shown in FIG. 6, the outer surface of the golf ball (53) may include dimples with different surface texturing (23) as described above and conventional dimples (54) with no surface texturing. This pattern also includes a plurality of great circles generally indicated at (GC) over the surface of the ball that intersect dimples incorporating directional surface texturing.

As described above, the outer surface of the golf ball of this invention may contain dimples that have been surface textured or a non-dimpled (land) surface that has been surface textured or combinations thereof. The surface textured dimples may be combined with conventional dimples to form the outer surface of the ball. Preferably, a golf ball according to the present invention has an outer surface comprising a plurality of dimples covering greater than 70 percent of the outer surface and at least 20 percent of the dimples incorporate surface texturing.

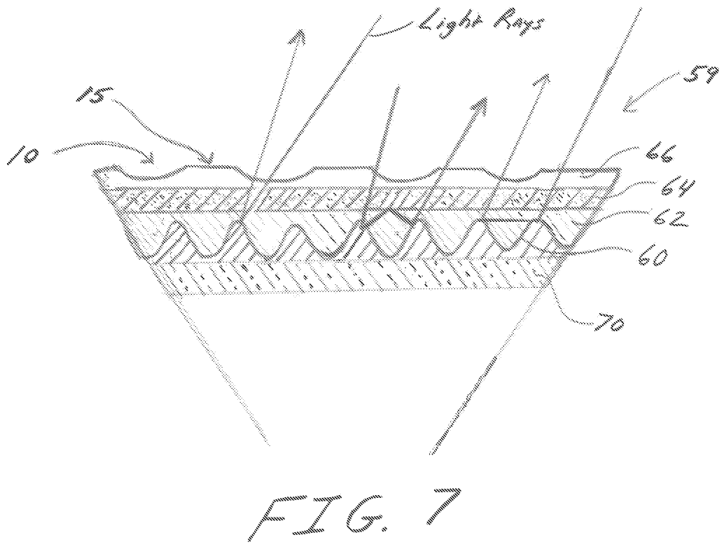

Referring to FIG. 7, in another embodiment, a concavo-convex surface pattern is used. The outer surface of the golf ball (59) includes the base (sub-coating) layer (60) having the concavo-convex pattern. The golf ball (59) can further include an inner cover layer (70) underlying the base layer (60). This base layer (60) is optionally coated with a semi-transparent metallic layer (62). The outer surface of the golf ball also can include an overlying decorative effect coating layer (62) and a transparent topcoat layer (64) as also described further below. Such concavo-convex surface patterns for decorative films are disclosed in Shibahara et al., US Patent Application Publication 2019/0224941, the disclosure of which is hereby incorporated by reference. In the present invention, the pattern or design of the concavo-convex surface of the pattern may be regular or irregular, and is not particularly limited. If the concavo-convex shape is formed by grooves, the width of the grooves is generally not less than approximately 1 μm or not less than approximately 10 μm, and not greater than approximately 1 mm or not greater than approximately 100 μm. By setting the width of the grooves of the concavo-convex shape to be within the range described above, visual effects (stereoscopic effect, flip-flop properties, and the like) that change depending on the viewing angle that are exhibited by the structure can be further enhanced.

In FIG. 7, the depth of the concavo-convex surface constituting the base layer (60) refers to a difference in height from a convex portion apex to a bottom portion of a contiguous concave portion. The depth of the concavo-convex surface may be uniform throughout an entirety of the concavo-convex surface, or may consist of a variety of values. The depth of the concavo-convex surface is generally not less than approximately 1 μm, not less than approximately 5 μm, not less than approximately 10 μm and not greater than approximately 100 μm, or approximately 50 μm or within a lower range. The depth of the concavo-convex shape contributes to the reflection and/or scattering of incident visible light rays. For example, in cases where the depth of the concavo-convex shape is shallow, the incident visible light rays reflect at the concavo-convex surface and enter as-is into the semi-transparent metallic layer. On the other hand, in cases where the depth of the concavo-convex shape is deep, there are cases in which intensity variations occur in the reflected light such as the visible light rays that are reflected at the concavo-convex surface enter an adjacent concavo-convex surface and reflect at the surface thereof. As a result, the visibility of the concavo-convex shape pattern can fluctuate.

As described above, the outer surface of the golf balls of this invention can have various surface patterns. The golf balls of this invention can be produced in a wide variety of colors, such as white, yellow, orange, green, red, and pink, and are typically colored by painting the outer surface of the ball, or by incorporating pigment directly into the cover composition. As described further below, a semi-transparent metallic coating, and/or a decorative effect coating, and/or a transparent topcoat can be applied to the surface textured outer surfaces of the golf ball. This combination of layers provides a unique, visually distinct appearance as described further below. The resulting golf balls of this invention reflect light in a much more random, less uniform manner than prior art golf balls. The golf balls of this invention are aesthetically pleasing and provide a creative look.

### Semi-Transparent Metallic Coating

As show in FIG. 7, in one embodiment of the present invention, a semi-transparent metallic coating layer (62) is applied over the surface textured base layer (60) having the concavo-convex pattern. The semi-transparent metallic coating layer may be a brightening (metallic) resin layer in which brightening (metallic) pigments such as aluminum flakes, vapor-deposited aluminum flakes, metal oxide-coated aluminum flakes, or colored aluminum flakes, or pearl brightening material, such as flake or synthetic mica covered with a metal oxide such as titanium oxide, or iron oxide, are dispersed in a binder resin such as acrylic resin, or polyurethane resin. Acrylic polyurethanes, polyureas, polyesters, polyester acrylics, and epoxies also can be used as resins in accordance with this invention. Preferably, the brightening (metallic) pigments are present in the coating in an amount of about 1% to about 30 wt. % based on total solids in the semi-transparent metallic coating wt.

As used herein, a “semi-transparent” or “translucent” layer preferably has an average transmittance of visible light (e.g., between about 380 nm and about 770 nm or alternately between about 400 nm and about 700 nm) of less than about 80% and preferably about 75% or less, and the underlying layer is not completely hidden.

As used herein, a “clear” or “transparent” layer preferably has an average transmittance of visible light (e.g., between about 380 nm and about 770 nm or alternately between about 400 nm and about 700 nm) of at least about 80% or greater and preferably about 90% or greater. The average transmittance referred to herein is typically measured for incident light normal (i.e., at approximately 90°.) to the plane of the object and can be measured using any known light transmission apparatus and method, e.g., a UV-Vis spectrophotometer. The semi-transparent metallic layer may have a variety of visible light transmissions depending on the brightness (reflectivity) and the like of the base layer.

The term “flip-flop properties” refers to appearance performance by which a pattern appears and disappears due to a concavo-convex shape on the outer surface of the ball. For example, complex design patterns including multiple stripes can appear in a visible area around a center of the golf ball, however, stripe patterns and other designs can disappear in an invisible area adjust to the visible area.

In another embodiment, the semi-transparent metallic layer may be a thin metal film containing a metal selected from aluminum, nickel, gold, platinum, chromium, iron, copper, tin, indium, silver, titanium, lead, zinc, germanium, or the like, or alloys or compounds of the same, formed by vacuum deposition, sputtering, ion plating, or the like.

The semi-transparent metallic coating layer may have a thickness of about 0.1 μm to about 50 μm. In preferred embodiments, the semi-transparent metallic layer coating may have a thickness of about 1 μm to 45 μm, or about 2 μm to 40 μm or about 4 μm to 30 μm. These coating layers have a thickness that is considerably less than the polymeric layers used to construct a traditional golf ball, for example, two-piece, three-piece, four-piece, and five-piece golf balls as described above. Semi-transparent metallic coating layers having a thickness in this range tend to have a good balance between reflecting and transmitting the incident light. In this way, the semi-transparent metallic coating layer helps impart unique visual effects to the golf ball construction of this invention.

### Decorative-Effect Coating

As show in FIG. 7, in one embodiment of the present invention, a semi-transparent decorative-effect coating layer (64) is applied over the semi-transparent metallic coating layer (62). The semi-transparent decorative-effect layer (64) coating layer contains a material that imparts a directional light reflectance, scattering, absorption, or optically variable appearance to the substrate in or on which they are applied. That is, the decorative-effect coating layer provides unique visual effects to the golf ball construction of this invention. The decorative-effect coating layer (64) is based on effect pigments which are typically defined as flake or platy structures that impart a directional light reflectance, scattering, absorption, or optically variable appearance to the substrate in or on which they are applied. P. J. Nowak, “Effect Pigments,” in Paint and Coating Testing Manual: 15th, Edition of the Gardner-Sward Handbook, ed. J. Koleske (West Conshohocken, Pa.: ASTM International, 2012), 256-271. As discussed above, the semi-transparent metallic layer (62) is optional. Thus, in some embodiments, the decorative-effect coating layer (64) is applied directly over the base (sub-coating) layer (60).

The effect pigments include absorption pigments, metal effect pigments, and pearlescent pigments. Absorption pigments represent true colors, as they absorb part of the light that hits them and scatter the rest. This phenomenon gives them their own body color. In contrast, metal effect pigments reflect almost all the light like lots of tiny mirrors. This gives them their high surface luster. Pearlescent pigments have a layered structure so that light is reflected at different levels in the pigment. The reflected waves interfere with each other and this creates a brilliant interference color.

In one preferred embodiment, color-shifting pigments can be used in the visual effect layer. Color-shifting pigments that have a first color at a first angle of incident light or viewing and a second color different from the first color at a second angle of incident light or viewing. Such color-shifting pigments are disclosed in Phillips et al., U.S. Pat. No. 7,235,300, the disclosure of which is hereby incorporated by reference.

Various other visual effect materials can be used in accordance with the present invention. For example, metallics, fluorescents, optical brighteners, pearlescents, phosphorescents, luminescents, edge-effect pigments, pigments, dyes and/or tinting agents can be dispersed in the decorative effect layer.

Metallics include any suitable metal, but lustrous metals with a high aspect ratio are preferred. Metallics may be in the form of flakes, filler, chopped fiber, or whiskers. Metallics may also comprise iridescent glitter and metallized film. The metallic particles preferably have faces that have an individual reflectance of over 75%, more preferably at least 95%, and most preferably 99-100%. For example, flat particles with two opposite faces can be used.

Titanium dioxide pigment is preferably used as light-reflective material, because of its light scattering properties including reflectivity and refraction. As the light strikes the surface of the composition, most of the light will be reflected because of the titanium dioxide pigment concentration. The light strikes the surface of the pigment (which has a relatively high refractive index in contrast to the binder resin), the light is bent and reflected outwardly. The portion of light which is not reflected will pass through the particles and will be bent in different direction. Other useful metal (or metal alloy) flakes, plates, powders, or particles may include bismuth boron, brass, bronze, cobalt, copper, nickel, chrome, iron, molybdenum, nickel powder, stainless steel, zirconium aluminum, tungsten metal, beryllium metal, zinc, or tin. Other metal oxides may include zinc oxide, iron oxide, aluminum oxide, magnesium oxide, zirconium oxide, and tungsten trioxide.

Metalized films and foils, particularly metalized polyester films and aluminum foil, and glitter specks, which comprises very small plastic pieces painted in metallic, neon, and iridescent colors to reflect light also can be used as reflective fillers in accordance with this invention.

The particle size of the metallic particles should be relatively small. The particle size preferably is 0.1 mm-1.0 mm more preferably 0.2 mm-0.8 mm, and most preferably 0.25 mm-0.5 mm. The quantity of metallic particles may vary widely, as it will depend upon the desired effect and is best determined experimentally. In general, an aesthetically pleasing reflective appearance can be obtained by using about 0.1-10, or more preferably 1-4, parts by weight metallic particles in the polymeric material. Metallics such as aluminum flakes, vapor-deposited aluminum flakes, metal oxide-coated aluminum flakes, or colored aluminum flakes can be used.

Pearlescent pigments also can be used in the decorative-effect coating layer. Such pigments attempt to mimic the inherent gleam and luster of natural pearls. This is achieved by utilizing the light reflection characteristics of microscopic platelets and the optimization of their diffraction and diffusion properties. There are several types of pearl pigments commercially available, including natural pearl essence, bismuth oxychloride crystals, and oxide-coated micas. There are also several other types of substrates that can be oxide coated, such as glass flakes and alumina plates. Preferably, platelets of mica that are coated with thin layers of titanium dioxide (TiO₂) and/or iron oxide, and the like are used. The broad face of the platelets can range from 4 microns to 1,000 microns across and are approximately 0.5 microns thick, although synthetic micas can achieve thicknesses of less than 0.25 microns. The platelets of coated mica are very smooth, so they are light reflective while maintaining a high degree of transparency, which means only a portion of the light is reflected. The portion that is not reflected is transmitted through the platelet to the next layer where it. can be further reflected.

In one embodiment, a pigment mixture composition of: (a) a mica-based luster pigment consisting of a metal oxide coated mica in an amount of from about 5 wt. % to about 50 wt. %; and (b) titanium dioxide-coated alumina in an amount of from about 50 wt. % to about 95 wt. % is used. Such mixtures are described in Hogge et al., U.S. Pat. No. 9,205,304, the disclosure of which is hereby incorporated by reference. Preferably, the semi-transparent metallic coating comprises the pigment mixture composition in an amount of about 1% to about 30 wt. % based on total solids in the semi-transparent metallic coating. In another embodiment, the pigment is selected from the group consisting of: a) calcium aluminum borosilicate coated with a metal oxide; and b) silicon dioxide platelets coated with metal oxide; and mixtures thereof are used. Such mixtures are described in Morgan et al., U.S. Pat. No. 9,333,394, the disclosure of which is hereby incorporated by reference.

The decorative-effect coating layer can be a resin layer in which a material that provides the visual effect is dispersed in a resin such as an acrylic or polyurethane resin. Polyureas, acrylic polyurethanes, polyesters, polyester acrylics, and epoxies also can be used as resins in accordance with this invention. This resin is applied to the outer surface of the golf ball. In other embodiments, the decorative-effect layer may be a metal thin film containing a metal selected from aluminum, nickel, gold, platinum, chromium, iron, copper, tin, indium, silver, titanium, lead, zinc, or germanium, or alloys or compounds of the same, that is formed by vacuum deposition, sputtering, ion plating, or the like on a layer that constitutes the decorative film such as the transparent resin layer or the base layer. Such a thin metal film has high luster and, therefore, can provide particularly excellent visual effects.

In some embodiments, fluorescents can be used in the decorative-effect coating layer. Fluorescent materials useful in the present invention are commercially available fluorescent pigments and dyes. Some are described in U.S. Pat. Nos. 2,809,954; 2,938,873; 2,851,424; or 3,412,036, which are incorporated by reference herein. A commercial source for these products is Dayglo Color Corporation. As described in the cited patents, these fluorescent daylight materials are organic co-condensates. They are typically composed of melamine, an aldehyde such as formaldehyde, a heterocyclic compound and/or an aromatic sulfonamide. Typical of such materials is Solvent Yellow 44, compounds which are sold by DayGlo under the trademark Saturn Yellow and by Lawler under the trademark Lemon Yellow. The amount of fluorescent material to be used is largely a matter of choice depending on the brightness desired. However, it is preferred that the amount of fluorescent dye be from about 0.01% to about 0.5% by weight of the composition and the amount of fluorescent pigment be from about 0.5% to about 6% by weight of the composition.

In general, fluorescent dyes useful in the present invention include dyes from the thioxanthene, xanthene, perylene, perylene imide, coumarin, thioindigoid, naphthalimide and methine dye classes. Useful dye classes have been more completely described in U.S. Pat. No. 5,674,622, which is incorporated herein by reference in its entirety. Representative yellow fluorescent dye examples include, but are not limited to: Lumogen F Orange™ 240 (BASF, Rensselaer, N.Y.); Lumogen F Yellow™ 083 (BASF, Rensselaer, N.Y.); Hostasol Yellow™ 3G (Hoechst-Celanese, Somerville, N.J.); Oraset Yellow™ 8GF (Ciba-Geigy, Hawthorne, N.Y.); Fluorol 088™ (BASF, Rensselaer, N.Y.); Thermoplast F Yellow™ 084 (BASF, Rensselaer, N.Y.); Golden Yellow™ D-304 (DayGlo, Cleveland, Ohio); Mohawk Yellow™ D-299 (DayGlo, Cleveland, Ohio); Potomac Yellow™ D-838 (DayGlo, Cleveland, Ohio); and Polyfast Brilliant Red™ SB (Keystone, Chicago, Ill.).

In some embodiments, the visually enhancing means comprises edge-effect pigments. Edge-effect pigments are attracted to the edges or sharper contours of the surfaces to which they are applied and thus leave higher concentrations of pigment in such areas. Edge-effect pigments are sold by Bayer Co under the description “Fantasia Colors and Special Effects” and include Leda Edge-Effects. Edge-effect pigments are also sold by Merck Co under the tradenames Miraval, Iriodin, Colorstream, Xirallic, Solarflair, Lazerflair, and Florapearl.

The decorative-effect coating layer may additionally comprise pigment or dye in an amount sufficient to provide a hue to the material but maintain translucence. That is, the substantially transparent polymeric matrix may be lightly colored or tinted so long as the underlying layer remains visible. Suitable dyes include fluorescent dyes such as from the thioxanthene, xanthene, perylene, perylene imide, coumarin, thioindigoid, naphthalimide and methine dye classes. Useful dye classes have been more completely described in U.S. Pat. No. 5,674,622, which is incorporated herein by reference in its entirety. Representative yellow fluorescent dye examples include, but are not limited to: Lumogen F Orange™ 240 (BASF, Rensselaer, N.Y.); Lumogen F Yellow™ 083 (BASF, Rensselaer, N.Y.); Hostasol Yellow™ 3G (Hoechst-Celanese, Somerville, N.J.); Oraset Yellow™ 8GF (Ciba-Geigy, Hawthorne, N.Y.); Fluorol 088™ (BASF, Rensselaer, N.Y.); Thermoplast F Yellow™ 084 (BASF, Rensselaer, N.Y.); Golden Yellow™ D-304 (DayGlo, Cleveland, Ohio); Mohawk Yellow™ D-299 (DayGlo, Cleveland, Ohio); Potomac Yellow™ D-838 (DayGlo, Cleveland, Ohio) and Polyfast Brilliant Red™ SB (Keystone, Chicago, Ill.).

The decorative-effect coating layer may have a thickness of about 0.1 μm to about 50 μm. In preferred embodiments, the decorative-effect layer coating may have a thickness of about 1 μm to 45 μm, or from about 2 μm to 40 μm, or from about 4 μm to 30 μm. These coating layers have a thickness that is considerably less than the polymeric layers used to construct a traditional golf ball, for example, a two-piece, three-piece, four-piece, and five-piece golf balls as described above. Semi-transparent decorative-effect coating layers having a thickness in this range tend to have a good balance between reflecting and transmitting the incident light. In this way, the decorative-effect coating layer helps impart unique visual effects to the golf ball construction of this invention.

### Clear Topcoat

A transparent topcoat may be applied to the outer surface of the golf ball in accordance with the present invention. This transparent topcoat protects any printed indicia, provides high gloss, provides abrasion or wear-resistance, and generally enhances the overall aesthetics of the ball. As show in FIG. 7, in one embodiment of the present invention, a transparent topcoat (66) is applied over the semi-transparent decorative effect layer (64).

The topcoat normally contains light stabilizers and optical brighteners, which both compete for absorption of the ultraviolet (UV) light. Optical brighteners absorb electromagnetic radiation in the ultraviolet portion of the spectrum and re-emit (i e., “fluoresce”) radiation in the visible portion of the spectrum. When applied to the exterior of a golf ball, optical brighteners enhance the whiteness and/or brightness of such balls. This whitening effect makes the materials appear less yellowish by increasing the overall amount of blue light reflected. In general, the brighteners are selected from one of the following classes: triazine-stilbenes (di, tetra-, or hexa-sulfonated); coumarins; imidazolines; diazoles; triazoles; benzooxazolines; and biphenyl-stilbenes; and mixtures thereof. The concentration of optical brighteners in the topcoat can be in the range of about 0.1 to about 5 weight percent based on the total weight of solids in the topcoat, and preferably in the range of about 0.5 to about 3.5 weight percent.

Light stabilizers protect against photodegradation initiated due to exposure to UV light. When the coating is exposed to UV radiation from the sunlight, this initiates degradation through a photo-oxidative process. Photo-oxidation is a chain-reaction process involving free radicals and hydroperoxide intermediates. Light stabilizers inhibit this process by absorption of the damaging UV radiation or by scavenging the reactive intermediates. Such stabilizers include ultraviolet (UV) absorbers which absorb ultraviolet radiation and have a high degree of inherent photostability; and hindred amine light stabilizers (HALs) which primarily function by scavenging the free-radical intermediates in the photo-oxidation process. These scavengers interrupt free radical reactions.

Suitable UV absorbers include, but are not limited to, triazines, benzoxazinones, benzotriazoles, benzophenones, benzoates, and the like. In some instances, light stabilizers such as Tinuvin® 571, 123, P, and 328, and 329 UV absorbers, commercially available from BASF, are included in the cover material. Adding the light stabilizers to the cover composition can help slow down discoloration due to exposure to the UV radiation. For example, the light stabilizers can be present in the cover composition in an amount in the range of about 1 to about 8 weight percent (wt. %) based on the weight of the composition. In other instances, the cover stock does not include any light stabilizers.

Preferably, the topcoat composition used for coating golf balls of this invention is a polyurethane, solvent-borne composition comprising a resin component and an isocyanate component. The Part A component of the coating preferably contains polyol, catalyst, solvent, UV absorbers, hindered amine light stabilizers, and optical brighteners as described further below. The Part B component of this coating preferably contains polyisocyanates such as hexamethylene diisocyanate, trimer of hexamethylene diisocyanate, or biuret of hexamethylene diisocyanate and solvents as also described further below. Aliphatic isocyanates are preferred since they have better ultraviolet (UV) light durability and lesser tendency to yellow when exposed to heat and light. The viscosity of the coating is adjusted using solvents including n-butyl acetate, t-butyl acetate, methyl amyl ketone (MAK), and ethyl acetate. Other solvent-borne formulations such as polyureas, acrylic polyurethanes, polyesters, polyester acrylics, and epoxies also can be used in accordance with this invention.

The transparent topcoat may have a thickness in the range of about 1 μm to about 50 μm. In preferred embodiments the transparent topcoat layer may have a thickness of about 2 μm to 40 μm, or from 4 μm to 30 μm.

### Golf Ball Construction

Different materials may be used in the construction of the golf balls of the present invention. For example, the golf ball may contain a single- or multi-layered core. In one preferred embodiment, a core assembly comprising an inner core (center) and surrounding outer core layer is made. Thermoset or thermoplastic compositions may be used to form the inner core and outer core layers. In one preferred embodiment, at least one of the core layers is formed from a rubber composition. Preferably, the rubber composition comprises polybutadiene rubber. More particularly, in one version, the ball contains a dual-core comprising an inner core (center) and surrounding outer core layer, each layer made of a polybutadiene rubber composition.

Suitable rubber compositions for forming at least one of the core layers include, but are not limited to, rubber compositions comprising a rubber material such as, for example, polybutadiene, ethylene-propylene rubber, ethylene-propylene-diene rubber, polyisoprene, styrene-butadiene rubber, polyalkenamers, butyl rubber, halobutyl rubber, or polystyrene elastomers. For example, thermoset rubber compositions containing polybutadiene rubber may be used to form both the inner core (center) and surrounding outer core layer in a dual-layered construction. In another version, at least one of the core layers is formed from a thermoplastic composition. For example, ionomer compositions comprising an ethylene acid copolymer containing acid groups such that less than 70% of the acid groups are neutralized (partially neutralized polymers) may be used. In another example, ionomer compositions comprising an ethylene acid copolymer containing acid groups such that greater than 70% of the acid groups are neutralized (highly neutralized polymers or HNPs) may be used. For example, thermoplastic ionomer compositions may be used to form both the inner core (center) and surrounding outer core layer in a dual-layered construction. In another example, a thermoset rubber composition may be used to form the inner core and a thermoplastic ionomer composition may be used to form the outer core. In yet another example, a thermoplastic ionomer composition may be used to form the inner core and a thermoset rubber composition may be used to form the outer core layer.

In one preferred embodiment, an intermediate layer is disposed between the single or multi-layered core and surrounding cover layer. These intermediate layers also can be referred to as casing or inner cover layers. The intermediate layer can be formed from any materials known in the art, including thermoplastic and thermosetting materials, but preferably is formed of an ionomer composition comprising an ethylene acid copolymer containing acid groups that are at least partially neutralized. Suitable ethylene acid copolymers that may be used to form the intermediate layers are generally referred to as copolymers of ethylene; C₃ to C₈ α, β-ethylenically unsaturated mono-or dicarboxylic acid; and optional softening monomer.

The golf ball may contain one or more cover layers. For example, a golf ball having a single-layered cover may be made. In another version, a golf ball having a two-layered cover including inner and outer cover layers may be made.

The cover layers of this invention provide the ball with a variety of advantageous mechanical and playing performance properties as well as aesthetic and decorative properties as discussed above. In general, the hardness and thickness of the different cover layers may vary depending upon the desired ball construction. In addition, as discussed above, an intermediate layer may be disposed between the core and cover layers. The cover layers preferably have high impact durability, toughness, and wear-resistance. The cover layers help players to generate high ball velocity off the tee and achieve long distances with their drives. At the same time, the cover layers provide the player with a more comfortable and natural feeling when striking the ball with a club. The cover layers help provide good spin control.

Suitable conventional materials that can be used to form a cover layer include, but are not limited to, polyurethanes; polyureas; copolymers, blends and hybrids of polyurethane and polyurea; olefin-based copolymer ionomer resins (for example, Surlyn® ionomer resins and DuPont HPF® 1000, HPF® 2000, and HPF® 1035; and HPF® AD 1172, commercially available from DuPont; Iotek® ionomers, commercially available from ExxonMobil Chemical Company; Amplify® IO ionomers of ethylene acrylic acid copolymers, commercially available from The Dow Chemical Company; and Clarix® ionomer resins, commercially available from A. Schulman Inc.); polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, commercially available from Arkema Inc; cross-linked trans-polyisoprene and blends thereof; polyester-based thermoplastic elastomers, such as Hytrel®, commercially available from DuPont or RiteFlex®, commercially available from Ticona Engineering Polymers; polyurethane-based thermoplastic elastomers, such as Elastollan®, commercially available from BASF; synthetic or natural vulcanized rubber; and combinations thereof. Polyurethanes, polyureas, and hybrids of polyurethanes-polyureas are particularly desirable because these materials can be used to make a golf ball having high resiliency and a soft feel. By the term, “hybrids of polyurethane and polyurea,” it is meant to include copolymers and blends thereof.

The resulting golf ball of this invention comprising the base (sub-coating) layer, for example a layer having a concavo-convex surface pattern; an optional semi-transparent metallic layer; an optional semi-transparent decorative effect layer; and a transparent topcoat layer, as described above, provides a golf ball having a visually distinct and aesthetically pleasing appearance. The golf ball cover structure of this invention is able to scatter the visible light rays in different directions to produce unique visuals. The different metallic and special effect materials in the semi-transparent layers help provide the ball with unique ornamental affects without sacrificing the playing performance properties of the ball such as resiliency and spin control. This combination of layers provides a unique, visually distinct appearance as light is reflected in a much more random, less uniform manner than prior art golf balls. The golf balls of this invention are aesthetically pleasing and provide a creative look.

When numerical lower limits and numerical upper limits are set forth herein, it is contemplated that any combination of these values may be used. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention.

It is understood that the manufacturing methods, compositions, constructions, and products described and illustrated herein represent only some embodiments of the invention. It is appreciated by those skilled in the art that various changes and additions can be made to the methods, compositions, constructions, and products without departing from the spirit and scope of this invention. It is intended that all such embodiments be covered by the appended claims.

We claim:

1. A golf ball comprising a core having at least one layer and a cover having at least one layer, wherein the cover comprises: i) an outer surface having dimples disposed thereon, at least a portion of the dimples comprising a perimeter and an inner surface, wherein the inner surfaces comprise at least one indented or protruding member, ii) a semi-transparent decorative-effect first coating overlying the outer surface of the cover, the decorative-effect coating comprising a color-shifting pigment such that the pigment has a first color at a first viewing angle and a second color different from the first color at a second viewing angle; and iii) a transparent second coating overlying the decorative-effect first coating.

2. The golf ball of claim 1, wherein each inner surface of the portion of the dimples comprises at least one indented channel.

3. The golf ball of claim 2, wherein the dimples comprise at least two indented channels, the channels being linear and wherein at least two of the channels have the same channel length and channel width.

4. The golf ball of claim 1, wherein each inner surface of the portion of the dimples comprises at least one indented sub-dimple.

5. The golf ball of claim 1, wherein each inner surface of the portion of the dimples comprises at least one protruding ridge.

6. The golf ball of claim 1, wherein the decorative-effect first coating further comprises a decorative material selected from the group consisting of phosphorescent pigments, luminescent pigments, light-reflective pigments, metallic pigments, pearlescent pigments, edge-effect pigments, color pigments and dyes, and mixtures thereof.

7. The golf ball of claim 1, wherein the decorative-effect first coating has a thickness in the range of about 0.1 μm to about 50 μm.

8. A golf ball comprising a core having at least one layer and a cover having at least one layer, wherein the cover comprises: i) an outer surface having dimples disposed thereon, the dimples overlying a layer comprising a series of protruding members that provide a concavo-convex pattern; ii) a semi-transparent metallic first coating overlying the outer surface of the cover, the metallic coating comprising a metallic pigment; and iii) a transparent second coating overlying the metallic first coating.

9. The golf ball of claim 8, wherein the semi-transparent metallic coating provides a decorative design on the outer surface of the cover and the decorative design appears and disappears depending upon a viewing angle.

10. The golf ball of claim 8, wherein the semi-transparent metallic coating comprises a metallic pigment selected from the group consisting of aluminum, titanium dioxide, iron oxide, and zinc pigments, metal-oxide coated mica pigments, and mixtures thereof.

11. The golf ball of claim 10, wherein the mica pigments are coated with titanium oxide or iron oxide.

12. The golf ball of claim 10, wherein the semi-transparent metallic coating comprises a pigment mixture composition of: (a) a metal-oxide coated mica pigment in an amount of about 5 wt. % to about 50 wt. %; and (b) titanium dioxide-coated aluminum pigment in an amount of about 50 wt. % to about 95 wt. %.

13. The golf ball of claim 12, wherein the semi-transparent metallic coating comprises the pigment mixture composition in an amount of about 1% to about 30 wt. % based on total solids in the semi-transparent metallic coating.

14. The golf ball of claim 8, wherein the semi-transparent metallic coating further comprises a metal film.

15. The golf ball of claim 8, wherein the semi-transparent metallic coating further comprises a decorative material selected from the group consisting of phosphorescent pigments, luminescent pigments, edge-effect pigments, color pigments and dyes and mixtures thereof.

16. The golf ball of claim 8, wherein the semi-transparent metallic coating has a thickness in the range of about 0.1 μm to about 50 μm.

17. A golf ball comprising a core having at least one layer and a cover having at least one layer, wherein the cover comprises: i) an outer surface having dimples disposed thereon, the dimples overlying a layer comprising a series of protruding members that provide a concavo-convex pattern; ii) a semi-transparent metallic first coating overlying the outer surface of the cover; iii) a semi-transparent decorative-effect second coating overlying the metallic first coating, the decorative-effect coating comprising a decorative material selected from the group consisting of color-shifting pigments, phosphorescent pigments, luminescent pigments, light-reflective pigments, metallic pigments, pearlescent pigments, edge-effect pigments, color pigments and dyes, and mixtures thereof; and iv) a transparent third coating overlying the decorative-effect second coating.

18. The golf ball of claim 17, wherein the decorative material is a color-shifting pigment such that the pigment has a first color at a first viewing angle and a second color different from the first color at a second viewing angle.

19. The golf ball of claim 17, wherein the decorative material is a light-reflective white pigment.

20. The golf ball of claim 17, wherein the decorative material is a pearlescent pigment.
